(19) United States
(12) Patent Application Publication
(10) Pub. No.: US 2009/0103330 A1
(43) Pub. Date: Apr. 23, 2009

(54) Light Fixture For Low Voltage Rail

(75) Inventor: Nelson Caldani, Wadsworth, IL (US)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: American Fluorescent Corporation, Chicago, IL (US)

(21) Appl. No.: 11/875,539

(22) Filed: Oct. 19, 2007

(51) Int. Cl. F21S 2/00

(52) U.S. Cl. 362/648

(57) ABSTRACT

A light fixture for use with a low-voltage rail is provided. The light fixture may include a rail connector, adapted to connect mechanically and electrically to the low-voltage rail, a ballast, adapted to convert power supplied by the low-voltage rail to a power suitable to illuminate a line voltage gas discharge bulb; and a low-voltage coupling, electrically and mechanically coupling the rail connector to the ballast. In one example, the ballast is located apart from the rail connector. The light fixture may further include a line voltage fluorescent bulb or compact fluorescent (CFL) bulb coupled to the ballast. In these examples, the ballast is further adapted to convert power supplied by the low-voltage rail to a power suitable to illuminate the line voltage fluorescent bulb. In another example, the light fixture may be equipped with a line voltage HID bulb coupled to the ballast, with the ballast being further adapted to convert power supplied by the low-voltage rail to a power suitable to illuminate the line voltage HID bulb.

### BACKGROUND

Low-voltage rail lighting systems are known. Generally, a transformer converts household line voltages (120V AC) to low-voltage e.g., 12-24V and applies it to a power distribution rail. The low-voltage may be AC or DC. One or more light fixtures may be hung from the rail. Typically, the light fixtures have low-voltage halogen bulbs, which are driven directly by the low-voltage power.

Safety is one of the advantages of known low-voltage rail systems. Conductors may be safely exposed, and users can make connections and install low-voltage portions of systems without a licensed electrician. The rails for low-voltage systems are also typically more attractive than line voltage track lighting systems. Also, the wiring for pendant light fixtures is made much slimmer and more attractive when relieved of the necessity to transmit line voltage all the way to the light fixture itself.

A main disadvantage known is halogen low-voltage rail lighting systems' power consumption. Halogen bulbs used in such systems are typically 50 W. Additionally, known halogen fixtures generate an undesirable amount of heat.

Line voltage fluorescent pendant fixtures are also known. Such fixtures typically bring 120V line voltage directly to a ballast for the fluorescent bulb or tube. This causes the wiring for a conventional fluorescent pendant fixture to be bulky and unattractive. Also, conventional fluorescent fixtures will not work with known low-voltage rail systems.

### SUMMARY

What is needed is a lighting fixture that can operate on a variety of low-voltage sources, including DC, 60 Hz AC, and high frequency AC (HF AC), and produce an output voltage suitable to excite a conventional line voltage 120V compact fluorescent (CFL) bulb. Thus, the advantages of the low-voltage rail structure may be used (e.g., safely exposed conductors, slim attractive wiring and fixtures), while at the same time providing the advantages of low power consumption and cooler operation provided by commonly available CFL bulbs. Also, the universal nature of the ballast (DC, 60 Hz AC, HF AC) ensures maximum compatibility with previously installed low-voltage halogen systems. Thus, by simply removing the halogen fixtures and adding the new CFL fixtures according to the present invention, one may substantially improve the energy efficiency of an existing lighting system without incurring the expense of changing the wiring or voltage supply.

A light fixture for use with a low-voltage rail is provided. The light fixture may include a rail connector, adapted to connect mechanically and electrically to the low-voltage rail, a ballast, adapted to convert power supplied by the low-voltage rail to a power suitable to illuminate a line voltage gas discharge bulb; and a low-voltage coupling, electrically and mechanically coupling the rail connector to the ballast. In one example, the ballast is located apart from the rail connector. The light fixture may further include a line voltage fluorescent bulb or compact fluorescent (CFL) bulb coupled to the ballast. In these examples, the ballast is further adapted to convert power supplied by the low-voltage rail to a power suitable to illuminate the line voltage fluorescent bulb. In another example, the light fixture may be equipped with a line voltage HID bulb coupled to the ballast. In this example, the ballast is further adapted to convert power supplied by the low-voltage rail to a power suitable to illuminate the line voltage HID bulb.

In another example, the light fixture of claim also includes a housing, which encloses the ballast, and the low-voltage coupling further comprises a rigid tube connecting the rail connector to the housing and a low-voltage line being disposed within the rigid tube. In another example, the low-voltage coupling comprises a coaxial cable including a low-voltage line. In this example, the coaxial cable provides both mechanical support to suspend the housing from the rail adapter and electrical connectivity to the ballast.

The ballast of the present invention may be configured to convert low-voltage DC power, low-voltage line-frequency AC power, and low-voltage high frequency AC power to a power suitable to illuminate a line voltage gas discharge bulb.

In another example, the housing may be connected directly to the rail connector, and the ballast is located inside the housing. A low voltage line electrically connects the ballast to the power supplied by the low voltage rail.

As used herein, the term “line voltage” means 120v AC, 220v AC, or any other voltage typically used in residential or commercial building wiring. The term “line voltage gas discharge bulb” means a gas discharge tube or bulb that is designed for, and is typically operated with, a ballast that operates with line voltage. Such gas discharge type bulbs include fluorescent bulbs and, more preferably, compact fluorescent (CFL) bulbs, ceramic metal halide (HID) bulbs, and other available bulbs. The term “low-voltage” means about 12-24 volts, and may include regulated DC, rectified but unregulated DC, 50-60 Hz AC, or high frequency (10 kHz to 45 kHz or more) AC voltages.

### BRIEF DESCRIPTION OF DRAWINGS

FIG. 1 is an exploded view of one example of a light fixture according to the present invention.

FIG. 2 is an example of a lighting system according to the present invention.

FIG. 3 is a cross section view of another example of a light fixture according to the present invention.

FIG. 4 is a cross section view of another example of a light fixture according to the present invention.

FIG. 5 is an exploded view of another example of a light fixture according to the present invention.

FIG. 6 is an illustration of another example of a light fixture according to the present invention.

FIG. 7 is an illustration of an example of a ballast according to the present invention.

FIG. 8 is an illustration of an example of one end of a ballast according to the present invention.

FIG. 9 is an illustration of one example of another end of a ballast according to the present invention.

### DETAILED DESCRIPTION

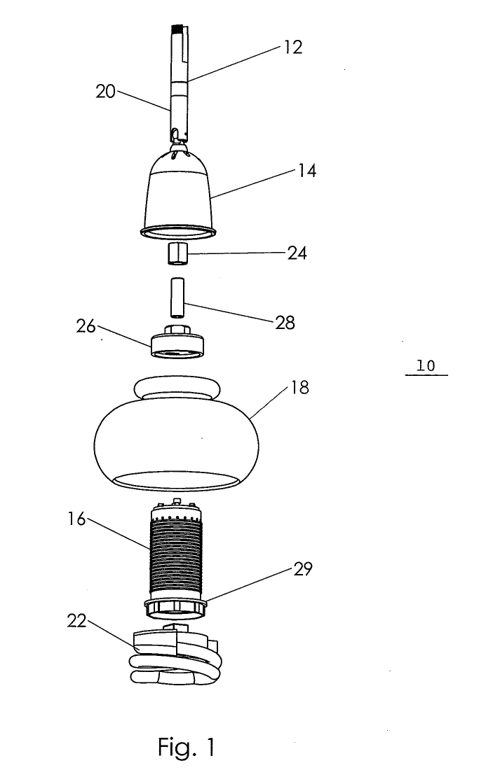

Referring to FIG. 1, a light fixture 10 according to one example of the present invention includes a rail connector 12, a housing 14 connected to the rail connector, a ballast 16 disposed within the housing 14, a shade 18 suspended from the housing 14, a low-voltage coupling 20 that couples the electrical power on the rail to the ballast 16, and a gas discharge bulb 22 adapted to engage the ballast 16. In some embodiments, the low-voltage coupling 20 may be terminated with a connector 24 and coupled to a ballast support 26. The ballast support 26 may be coupled to the housing 14 by coupler 28. The ballast 16 may be configured to releasably engage the ballast support 26.

In some embodiments, the gas discharge bulb 22 is a conventional line voltage compact fluorescent bulb. For example in the example illustrated in FIG. 1, the gas discharge bulb 22 is a spiral bulb. In other embodiments, the gas discharge bulb may be a line voltage HID ceramic metal halide bulb or any other type of gas discharge bulb intended for fixtures typically driven by line voltage power.

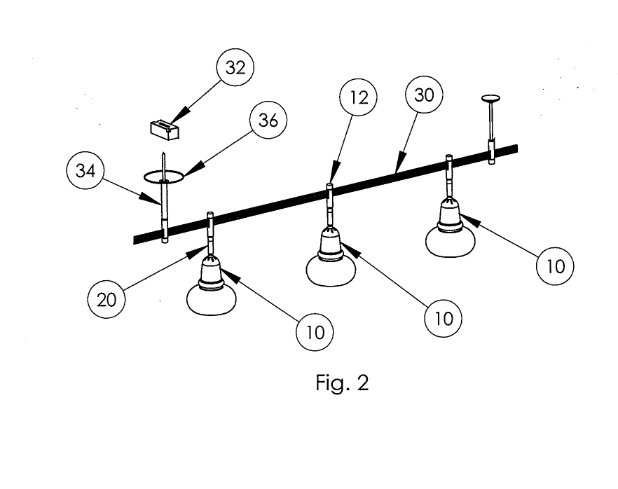

Referring to FIG. 2, a low-voltage rail system may include a rail 30, a transformer 32, one or more supports 34 to support the rail 30 from a ceiling, and one or more covers 36 to decoratively cover a hole in the ceiling to allow the support or powerfeed 34 to be attached to a joist, junction box or other structural component of the ceiling. One of the covers 36 may be adapted to conceal the transformer 32. One or more light fixtures 10 may be connected to the rail 30. Alternatively, there may be a mix of light fixtures, including conventional halogen light fixtures and light fixtures according to the present invention.

In one example, the low-voltage coupling 20 is a low-voltage coaxial line that provides both electrical connectivity to the ballast 16 and mechanical support to the housing 14. That is, the housing is coupled to the low-voltage coaxial line and is suspended from the rail 30 by low-voltage coaxial line. In other examples, low-voltage coupling 20 comprises a tube which provides mechanical support, and a low-voltage line is run inside the tube. Other examples of low-voltage couplings may be used without departing from the scope of the invention.

The transformer 32 converts 120V AC line power (or 220V AC) to low-voltage (12-24V) power. The low-voltage power may be AC, or it may be rectified to DC power. Additionally, the transformer may further convert the line power to low-voltage, high frequency (up to or exceeding 45 KHz) AC power. The transformer 32 is connected to and provides the low-voltage power to the rail 30. The rail 30 typically has exposed conductors to facilitate the connection of lighting fixtures.

The ballast 16 is configured to convert the low-voltage power supplied by the rail 30 to a voltage suitable to excite and cause the illumination of a gas discharge bulb, such as, but not limited to, a standard line voltage compact fluorescent (CFL) bulb. The ballast is adapted to be compatible with a broad spectrum of low-voltage power, from DC power all the way up to 45 KHz. In this regard, the ballast 16 may include a circuit for rectifying AC power, including high frequency AC power. The ballast may provide a receptacle suitable for plug in bulbs, such as GU-24 bulbs.

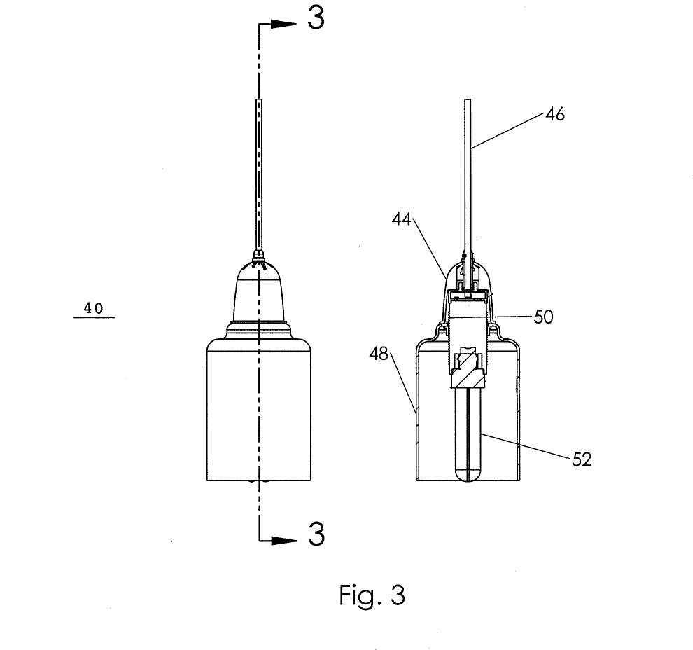

Referring to FIG. 3, a cross sectional view of an other example of a light fixture 40 is shown. In this example, housing 44 is coupled to and supported by low-voltage coupling 46. In this example, low-voltage coupling 46 comprises a coaxial cable and provides both mechanical support from the rail 30 to housing 44 and electrical connectivity from the rail 30 to a ballast 50. Also shown is this example is an alternate embodiment of a shade 48, and a bulb 52. In this example, the bulb 52 is a 13 W four pin quad bulb.

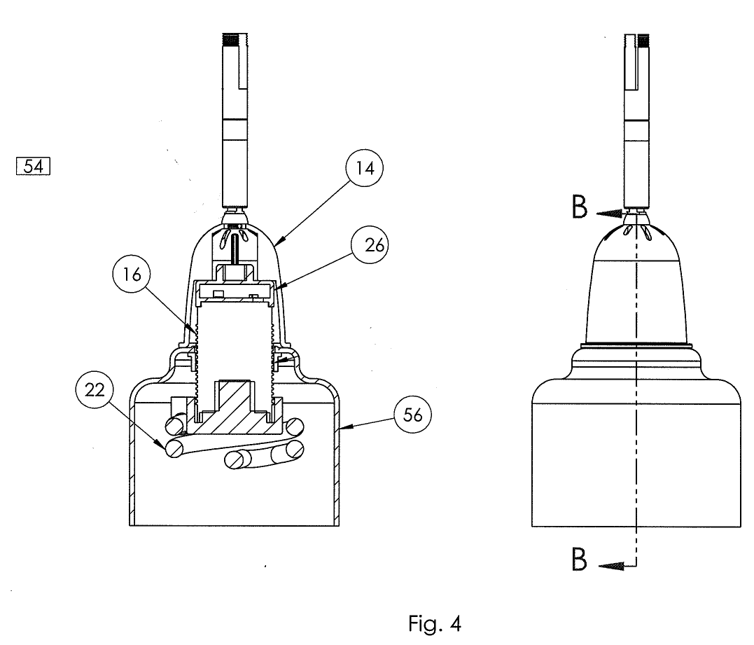

FIG. 4 includes a cross sectional illustration of another example of a light fixture 54. In this example, shade 56 is of a cylindrical shape. The housing 14, ballast 16 and bulb 22 may be the same as shown in FIG. 1. In this regard, the invention allows the substitution of various styles of shades without necessarily affecting the implementation of the housing, ballast, and bulb.

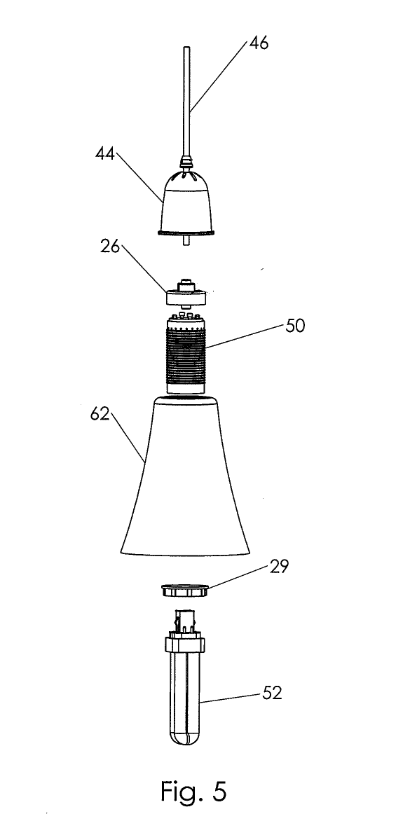

FIG. 5 is another example of a light fixture 60 according to the present invention. In this example, shade 62 is of a fluted shape. The housing 44, ballast 50 and bulb 52 may be the same as shown and described with respect to FIG. 3. This is another example where the invention allows the substitution of various styles of shades without necessarily affecting the implementation of the housing, ballast, and bulb.

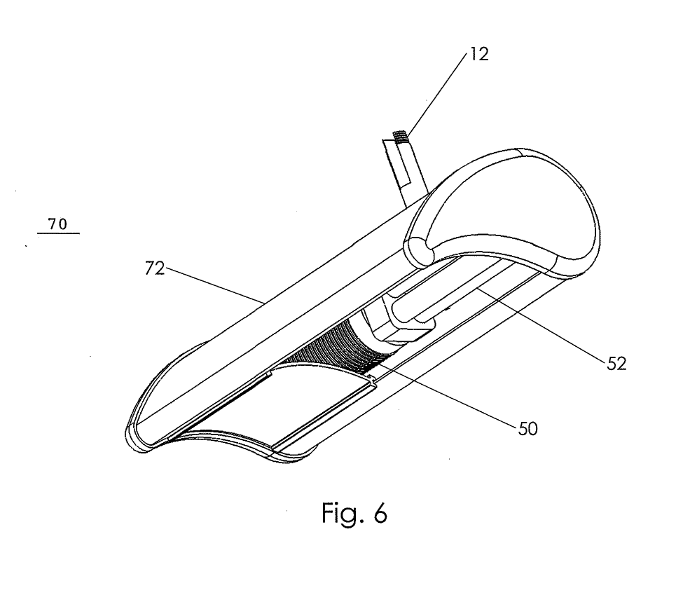

FIG. 6 illustrates another example of a light fixture 70 according to the present invention. In this example, housing 72 is coupled to the rail 30 and supported directly by rail connector 12. A low-voltage line or connector (not shown) couples the rail 30 to the ballast 50. Also shown in this example is the use of bulb 52, which is a 13 W four pin quad bulb. This example also provides an example wherein the invention is used without a separate shade, as the bulb 52 is within the housing 72 that also encloses the ballast 50.

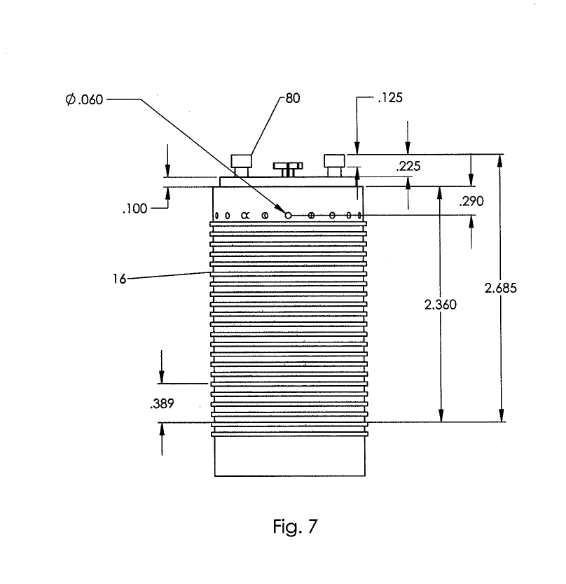

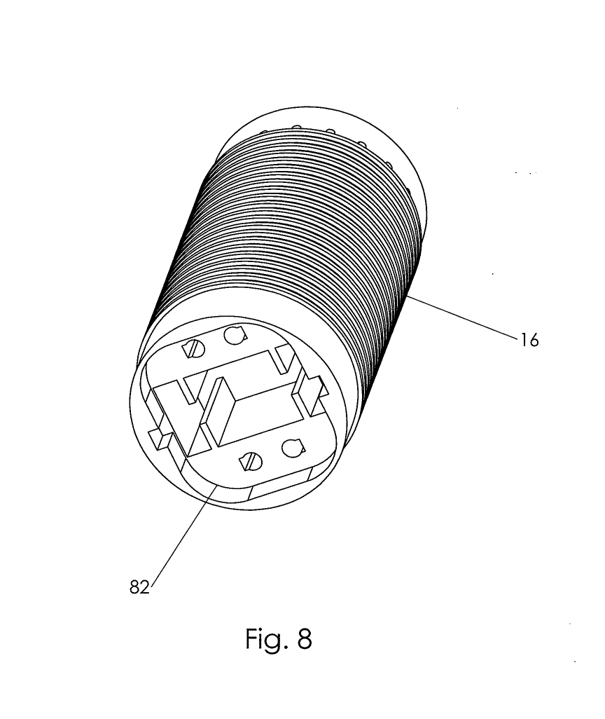

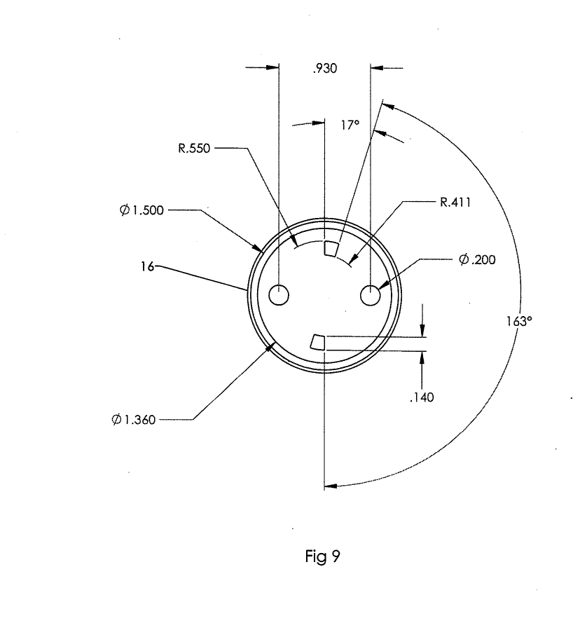

FIGS. 7, 8 and 9 illustrate an example of a ballast 16 that may be used in connection with any of the examples of the present invention. Ballast 16 includes a set of connectors and contacts 80 that may be twist-fit into engagement with ballast connection support 26. Also, ballast 16 may include a connector or socket adapted to engage a conventional line voltage CFL bulb. In the example illustrated in FIG. 8, the connector is a GU-24 connector adapted to receive 4-pin bulbs. However, the connector or socket 82 may be of any form factor suitable for engaging gas discharge bulbs typically intended for operation with line voltage fixtures.

What is claimed is:

1. A light fixture for use with a low-voltage rail, comprising:
a rail connector, adapted to connect mechanically and electrically to the low-voltage rail;
a ballast, adapted to convert power supplied by the low-voltage rail to a power suitable to illuminate a line voltage gas discharge bulb, the ballast located apart from the rail connector; and
a low-voltage coupling, electrically and mechanically coupling the rail connector to the ballast.

2. The light fixture of claim 1, further comprising a line voltage fluorescent bulb coupled to the ballast, wherein the ballast is further adapted to convert power supplied by the low-voltage rail to a power suitable to illuminate a line voltage fluorescent bulb.

3. The light fixture of claim 1, further comprising a line voltage compact fluorescent bulb coupled to the ballast, wherein the ballast is further adapted to convert power supplied by the low-voltage rail to a power suitable to illuminate a line voltage compact fluorescent bulb.

4. The light fixture of claim 1, further comprising a line voltage HID bulb coupled to the ballast, wherein the ballast is further adapted to convert power supplied by the low-voltage rail to a power suitable to illuminate the line voltage HID bulb.

5. The light fixture of claim 1, further comprising:
a housing, enclosing the ballast; and
the low-voltage coupling further comprises a rigid tube connecting the rail connector to the housing and a low-voltage line being disposed within the rigid tube.

6. The light fixture of claim 1, further comprising:
a housing, enclosing the ballast; and
the low-voltage coupling comprises a coaxial cable including a low-voltage line and providing mechanical support to suspend the housing from the rail adapter.

7. The light fixture of claim 1, wherein the ballast is configured to convert low-voltage DC power, low-voltage line-frequency AC power, and low-voltage high frequency AC power to a power suitable to illuminate a line voltage gas discharge bulb.

8. The light fixture of claim 6, wherein the ballast is configured to accept a plug-in compact fluorescent tube.

9. A light fixture for use with a low-voltage rail and a line voltage compact fluorescent bulb, the light fixture comprising:
a rail connector, adapted to connect mechanically and electrically to the low-voltage rail;
a ballast, adapted to convert low-voltage DC power, low-voltage line-frequency AC power, and low-voltage high frequency AC power to a power suitable to illuminate a plug in compact fluorescent bulb;
a housing, enclosing the ballast, the ballast and the housing located apart from the rail connector;
means for suspending the housing from the rail connector; and
a low-voltage line coupling the rail connector to the ballast.

10. The light fixture of claim 8, further comprising a plug-in compact fluorescent tube coupled to the ballast.

11. The light fixture of claim 8, wherein the means for suspending the housing from the rail connector comprises a rigid tube, and a low-voltage line being disposed within the rigid tube.

12. The light fixture of claim 8, wherein the means for suspending the housing from the rail connector comprises a cable or coaxial wire disposed between the rail connector and the housing, the cable including a low-voltage line and providing mechanical support to suspend the housing from the rail adapter.

13. A light fixture for use with a low-voltage rail, comprising:
a rail connector, adapted to connect mechanically and electrically to the low-voltage rail;
a ballast, adapted to convert low-voltage DC power, low-voltage line frequency AC power, and low-voltage, high frequency AC power to a power suitable to illuminate a line voltage gas discharge bulb;
a housing, coupled to the rail connector and enclosing the ballast; and
a low-voltage line connecting the rail connector to the ballast.
